(19) United States
(12) Patent Application Publication
(10) Pub. No.: US 2016/0366124 A1
(43) Pub. Date: Dec. 15, 2016

(54) CONFIGURATION AND AUTHENTICATION OF WIRELESS DEVICES

(71) Applicant: QUALCOMM Incorporated, San Diego, CA (US)

(72) Inventors: Olivier Jean Benoit, San Diego, CA (US); Peerapol Tinnakornsrisuphap, San Diego, CA (US)

(21) Appl. No.: 15/060,281

(22) Filed: Mar. 3, 2016

Related U.S. Application Data
(60) Provisional application No. 62/180,020, filed on Jun. 15, 2015.

(51) Int. Cl. H04L 29/06

(52) U.S. Cl. CPC H04L 63/0823; H04L 63/0876; H04L 63/061; H04L 63/0442

(57) ABSTRACT

An apparatus and method for registering and configuring a wireless device for use within a wireless local area network (WLAN) are disclosed. In at least one exemplary embodiment, a registration authority may obtain a public key and connection attributes of the wireless device. The registration authority may be distinct from the wireless device and an access point of the WLAN. The registration authority may provide the public key and the connection attributes to a certification authority. The certification authority, distinct from the registration authority, may certify the public key and generate a certificate for the wireless device. The certificate may authenticate the wireless device with access points or other wireless devices. In some embodiments, a certification revocation list may be generated to identify the certificates that may have expired or are otherwise invalid. The certification revocation list may permit or deny access of a wireless device to the WLAN.

### CROSS-REFERENCE TO RELATED APPLICATION

This application claims priority to U.S. Provisional Patent Application No. 62/180,020 entitled “ADDING A DEVICE TO A NETWORK, REMOVING A DEVICE FROM A NETWORK, AND CONNECTING TWO NETWORK DEVICES” filed Jun. 15, 2015, the entirety of which is incorporated by reference herein.

### TECHNICAL FIELD

The example embodiments relate generally to communication systems, and specifically to managing wireless device access within wireless networks.

### BACKGROUND OF RELATED ART

A wireless local area network (WLAN) may be formed by one or more access points (APs) that provide a shared wireless communication medium for use by a number of client devices. Each AP, which may correspond to a Basic Service Set (BSS), periodically broadcasts beacon frames to enable any client devices within wireless range of the AP to establish and/or maintain a communication link (e.g., a communication channel) with the WLAN.

In some WLANs, a client device may be configured for use with one or more APs in the WLAN using a public key encryption algorithm. Public key encryption (sometimes referred to as public/private key encryption) is a method of securely transferring data using a known (public) key and a secret (private) key. The public and private keys typically have a mathematical relationship with each other. In addition to transferring data, the public and private keys may verify messages and certificates, and may generate digital signatures. For example, the client device may share a public key (e.g., a public encryption key of the client device) with APs within the WLAN. The APs may use the client device's public key to authenticate and configure the client device. The authenticated client device may access (e.g., connect to) the APs within the WLAN. However, controlling access of the client device to the WLAN may be difficult after distribution of the client device's public key.

Accordingly, it is desirable to improve access control of the client device to the WLAN.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

In some aspects, a method of configuring a client device for use in a wireless network is disclosed. In accordance with example embodiments, a certification authority may authenticate the client device based, at least in part, on a public root identity key of the client device. The certification authority may receive a public transient identity key and a connection attribute of the client device. The public transient identity key and the connection attribute may be certified with a private certification authority key. The certified public transient identity key and the certified connection attribute may be transmitted to the client device.

In another aspect, a wireless device is disclosed that may include a transceiver, a processor and a memory to store instructions that, when executed by the processor, causes the wireless device to: authenticate, at a certification authority, a client device based, at least in part, on a public root identity key of the client device. The instructions further cause the wireless device to receive a public transient identity key and a connection attribute of the client device. The public transient identity key and the connection attribute may be certified with a private certification authority key and the certified public transient identity key and the certified connection attribute may be transmitted to the client device.

In another example embodiment, a method of establishing a communication link with a first wireless device is disclosed. A certificate identifier associated with a second wireless device may be transmitted to a certification status responder and a status associated with a certificate corresponding to the certificate identifier may be received from the certification status responder. The communication link may be established based, at least in part, on the received status of the certificate.

### BRIEF DESCRIPTION OF THE DRAWINGS

The example embodiments are illustrated by way of example and are not intended to be limited by the figures of the accompanying drawings.

FIG. 1 is a block diagram of a wireless system within which the example embodiments may be implemented.

FIG. 2 shows an illustrative flow chart depicting an example operation for authenticating and configuring the client device of FIG. 1, in accordance with example embodiments.

FIG. 3 is a block diagram of a wireless system within which the example embodiments may be implemented.

FIG. 4 shows an illustrative flow chart depicting another example operation for authenticating and configuring the client device of FIG. 1, in accordance with example embodiments.

FIG. 5 is a block diagram of a wireless system within which the example embodiments may be implemented.

FIG. 6 shows an illustrative flow chart depicting an example operation for de-authorizing one or more devices within a wireless local area network.

FIG. 7 shows an illustrative flow chart depicting an operation for establishing communications between two client devices, in accordance with example embodiments.

FIG. 8 is a block diagram of a wireless system within which the example embodiments may be implemented.

FIG. 9 shows an illustrative flow chart depicting another operation for establishing communications between two client devices, in accordance with example embodiments.

FIG. 10 shows an example wireless device that may be an embodiment of the access point, the client device, and/or the smartphone of FIG. 1.

Like reference numerals refer to corresponding parts throughout the drawing figures.

### DETAILED DESCRIPTION

The example embodiments are described below in the context of WLAN systems for simplicity only. It is to be understood that the example embodiments are equally applicable to other wireless networks (e.g., cellular networks, pico networks, femto networks, satellite networks), as well as for systems using signals of one or more wired standards or protocols (e.g., Ethernet and/or HomePlug/PLC standards). As used herein, the terms “WLAN” and “Wi-Fi®” may include communications governed by the IEEE 802.11 family of standards, Bluetooth, HiperLAN (a set of wireless standards, comparable to the IEEE 802.11 standards, used primarily in Europe), and other technologies having relatively short radio propagation range. Thus, the terms “WLAN” and “Wi-Fi” may be used interchangeably herein. In addition, although described below in terms of an infrastructure WLAN system including one or more APs and a number of client devices, the example embodiments are equally applicable to other WLAN systems including, for example, multiple WLANs, peer-to-peer (or Independent Basic Service Set, “IBSS”) systems, Wi-Fi Direct systems, and/or Hotspots.

In the following description, numerous specific details are set forth such as examples of specific components, circuits, and processes to provide a thorough understanding of the present disclosure. The term “coupled” as used herein means connected directly to or connected through one or more intervening components or circuits.

In addition, in the following description and for purposes of explanation, specific nomenclature is set forth to provide a thorough understanding of the example embodiments. However, it will be apparent to one skilled in the art that these specific details may not be required to practice the example embodiments. In other instances, well-known circuits and devices are shown in block diagram form to avoid obscuring the present disclosure. The example embodiments are not to be construed as limited to specific examples described herein but rather to include within their scopes all embodiments defined by the appended claims.

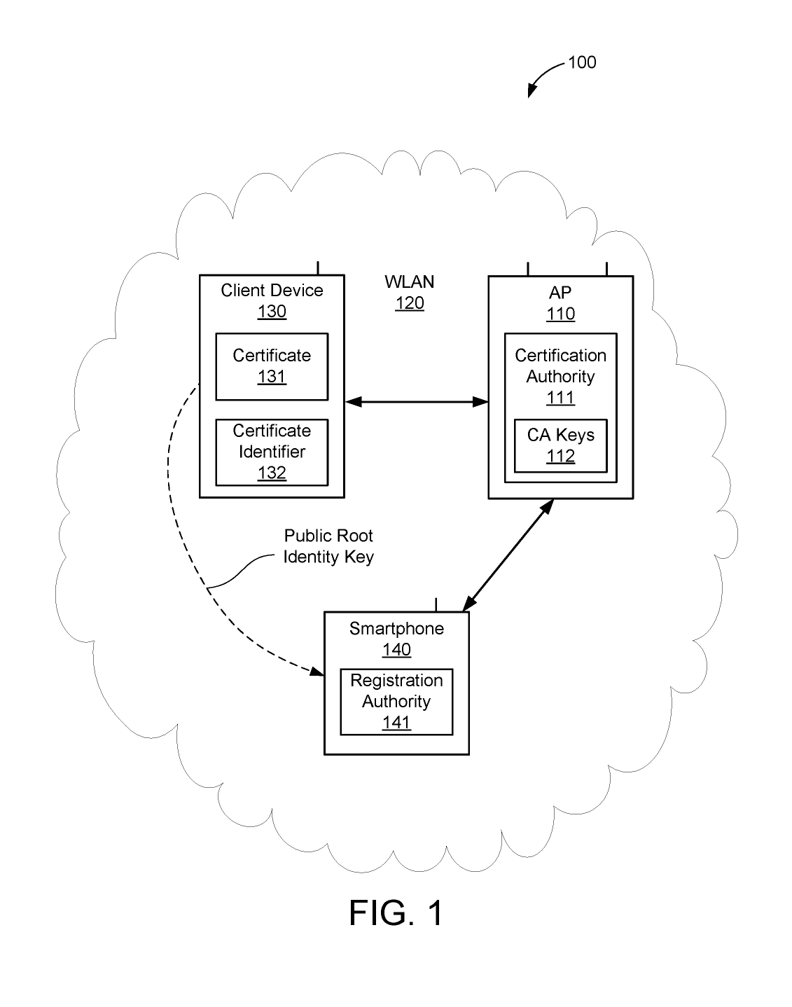

FIG. 1 is a block diagram of a wireless system 100 within which the example embodiments may be implemented. The wireless system 100 may include a client device 130 (e.g., a station or STA), a wireless access point (AP) 110, a smartphone 140, and a wireless local area network (WLAN) 120. The WLAN 120 may be formed by a plurality of Wi-Fi access points (APs) that may operate according to the IEEE 802.11 family of standards (or according to other suitable wireless protocols). Thus, although only one AP 110 is shown in FIG. 1 for simplicity, it is to be understood that the WLAN 120 may be formed by any number of access points such as the AP 110. In a similar manner, although only one client device 130 is shown in FIG. 1 for simplicity, the WLAN 120 may include any number of client devices. For some embodiments, the wireless system 100 may correspond to a single user multiple-input multiple-output (SU-MIMO) or a multi-user MIMO (MU-MIMO) wireless network. Further, although the WLAN 120 is depicted in FIG. 1 as an infrastructure BSS, for other example embodiments, the WLAN 120 may be an IBSS, an ad-hoc network, or a peer-to-peer (P2P) network (e.g., operating according to the Wi-Fi Direct protocols).

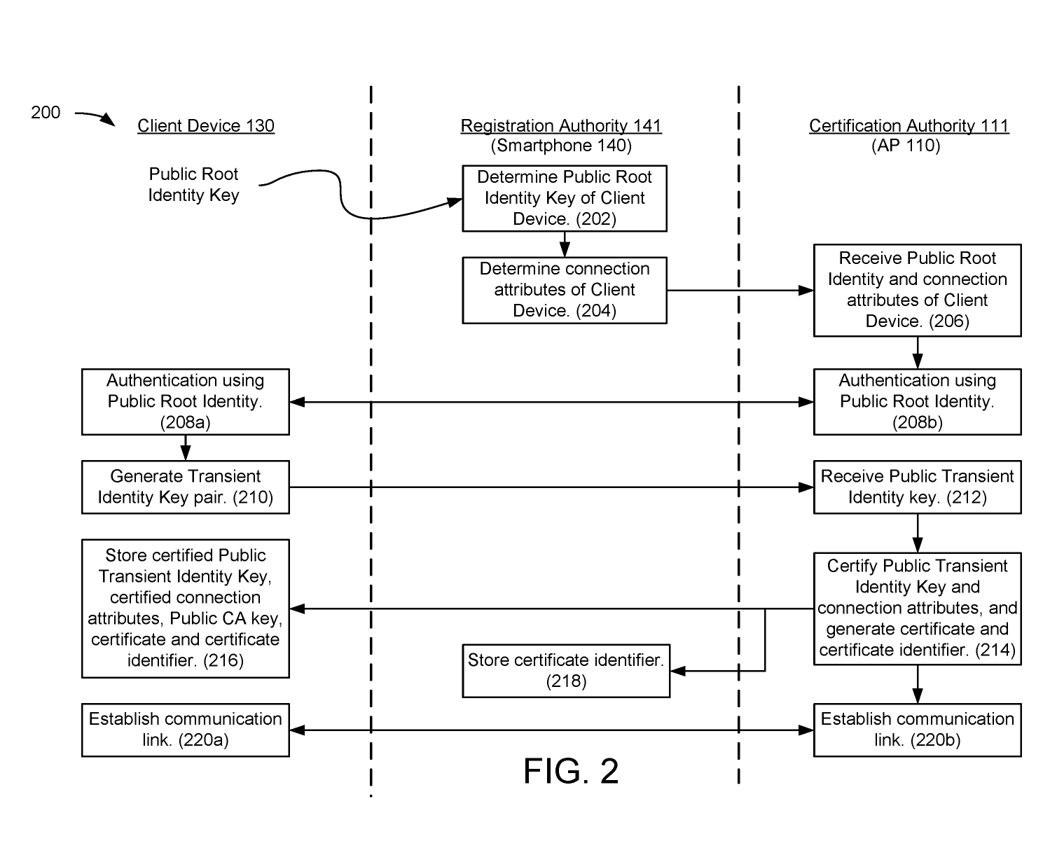

Each of the client device 130 and the smartphone 140 may be any suitable Wi-Fi enabled wireless device including, for example, a cell phone, personal digital assistant (PDA), tablet device, laptop computer, or the like. The client device 130 and/or the smartphone 140 may also be referred to as a user equipment (UE), a subscriber station, a mobile unit, a subscriber unit, a wireless unit, a remote unit, a mobile device, a wireless communications device, a remote device, a mobile subscriber station, an access terminal, a mobile terminal, a wireless terminal, a remote terminal, a handset, a user agent, a mobile client, a client, or some other suitable terminology. For some embodiments, the client device 130 and/or the smartphone 140 may include one or more transceivers, one or more processing resources (e.g., processors and/or ASICs), one or more memory resources, and a power source (e.g., a battery). The memory resources may include a non-transitory computer-readable medium (e.g., one or more nonvolatile memory elements, such as EPROM, EEPROM, Flash memory, a hard drive, etc.) that stores instructions for performing operations described below with respect to FIGS. 2, 4, 6, 7, and 9.

The AP 110 may be any suitable device that allows one or more wireless devices to connect to a network (e.g., a local area network (LAN), wide area network (WAN), metropolitan area network (MAN), and/or the Internet) via the AP 110 using Wi-Fi, Bluetooth, or any other suitable wireless communication standards. For at least one embodiment, the AP 110 may include one or more transceivers, one or more processing resources (e.g., processors and/or ASICs), one or more memory resources, and a power source. In some embodiments, the AP 110 may also be any suitable Wi-Fi and network enabled device including, for example, a cell phone, PDA, tablet device, laptop computer, or the like. The memory resources may include a non-transitory computer-readable medium (e.g., one or more nonvolatile memory elements, such as EPROM, EEPROM, Flash memory, a hard drive, etc.) that stores instructions for performing operations described below with respect to FIGS. 2, 6, and 9.

For the AP 110, the client device 130, and the smartphone 140, the one or more transceivers may include Wi-Fi transceivers, Bluetooth transceivers, cellular transceivers, and/or other suitable radio frequency (RF) transceivers (not shown for simplicity) to transmit and receive wireless communication signals. Each transceiver may communicate with other wireless devices in distinct operating frequency bands and/or using distinct communication protocols. For example, the Wi-Fi transceiver may communicate within a 2.4 GHz frequency band and/or within a 5 GHz frequency band in accordance with the IEEE 802.11 specification. The cellular transceiver may communicate within various RF frequency bands in accordance with a 4G Long Term Evolution (LTE) protocol described by the 3rd Generation Partnership Project (3GPP) (e.g., between approximately 700 MHz and approximately 3.9 GHz) and/or in accordance with other cellular protocols (e.g., a Global System for Mobile (GSM) communications protocol). In other embodiments, the transceivers included within the client device may be any technically feasible transceiver such as a ZigBee transceiver described by a specification from the ZigBee specification, a WiGig transceiver, and/or a HomePlug transceiver described a specification from the HomePlug Alliance.

The client device 130 is authenticated and configured before it can access any services and/or networks. In some embodiments, the smartphone 140 may aid and/or initiate the authentication and/or the configuration of the client device 130. Authentication and configuration of the client device 130 may establish a trusted and/or encrypted connection between the client device 130 and the AP 110. Authentication of the client device 130 may involve public/private key encryption. Those skilled in the art will appreciate that public/private key encryption techniques may encrypt and decrypt messages between wireless devices such as client device 130 and the AP 110. In some embodiments, other security mechanisms may be used in addition to, or alternately from the public/private key encryption described herein.

The authentication and/or configuration of the client device 130 may be based, at least in part, on public keys and/or connection attributes obtained by a registration authority 141 and/or signed certificates provided by a certification authority 111. For example, the registration authority 141 may determine a public Root Identity Key and/or the connection attributes of the client device 130. The public Root Identity Key may be a part of a Root Identity Key pair (sometimes referred to as an identity key pair) associated with the client device 130. The Root Identity Key pair may be assigned to (e.g., programmed into) the client device 130 during manufacture. As shown in FIG. 1, the smartphone 140 may include the registration authority 141. In other embodiments, the registration authority 141 may be included within any technically feasible device within the WLAN 120. For example, the AP 110 may include the registration authority 141 (not shown for simplicity).

The registration authority 141 may determine the public Root Identity Key of the client device 130 in an out-of-band manner. For example, the smartphone 140 may include an optical device (e.g., camera) to scan labels and/or images. The client device 130 may include a label imprinted with a quick response (QR) code that may display the public Root Identity Key or may direct a scanning device to retrieve the public Root Identity Key from a remote device or service. Thus, the QR code may directly or indirectly provide the public Root Identity Key of the client device 130 to the registration authority 141.

In other embodiments, other out-of-band methods may determine the public Root Identity Key. For example, a near field communication (NFC) link or a Bluetooth Low Energy (BLE) link may convey the public Root Identity Key from the client device 130 to the smartphone 140. Although only NFC links and BLE communication links are described herein, any other technically feasible communication link may be used.

In another embodiment, a user may provide the public Root Identity Key to the smartphone 140. For example, a human readable display of the client device 130 may display the public Root Identity Key which may then be entered by the user through a user interface (e.g., keyboard or touch screen) of the smartphone 140.

The connection attributes of the client device 130 may include one or more connection aspects of the client device 130 that may be determined, at least in part, by a user or a network administrator. For example, a first connection attribute may be a connection profile that describes a permitted connection time when the client device 130 (which may be referred to by a device name) may access the WLAN 120. The access may be limited, for example, by a time of day, or by a range of calendar dates. A second connection attribute may be a data throughput limit. For example, the client device 130 may be limited to a maximum data rate or a maximum number of transferred bytes. A third connection attribute may be an availability attribute where the client device 130 may be “publically” available (e.g., accessible by any wireless device within the WLAN 120) or “privately” available (e.g., accessible to a limited number of wireless devices within the WLAN 120). A fourth connection attribute may be a client device user attribute that determines whether the user is a “registered user” (e.g., whether the user has been previously registered with the registration authority 141) or is a “guest user”. A fifth connection attribute may be a peer-to-peer attribute that indicates whether the client device 130 is capable of peer-to-peer communication (e.g., communicate through a peer-to-peer link).

In some embodiments, the smartphone 140 may provide a user interface for the user and/or network administrator to enter the connection attribute information. In other embodiments, the connection attribute information may be transmitted to or retrieved by the registration authority 141. Although only five attributes are described herein for simplicity, any number of attributes may be associated with the client device 130.

Next, the registration authority 141 (via the smartphone 140) may provide the public Root Identity Key and the connection attributes to the certification authority 111. The smartphone 140 may communicate with the AP 110 through a previously established trusted connection. For example, a secure communication link between the smartphone 140 and the AP 110 may have been established before the public Root Identity Key and/or the connection attributes were determined by the registration authority 141. Thus, the public Root Identity Key and the connection attributes may be securely transmitted to the certification authority 111 and the AP 110. As shown in FIG. 1, the certification authority 111 may be included within the AP 110. In other embodiments, the certification authority 111 may be included within any technically feasible device within the WLAN 120. For example, the smartphone 140 may include the certification authority 111 (not shown for simplicity).

The AP 110 may authenticate and configure the client device 130 using the public Root Identity Key. For example, the AP 110 may transmit a message to the client device 130 using the public Root Identity Key. The client device 130 may determine a Transient Identity Key pair (sometimes referred to as a Network Provisioning Key pair) that includes public and private Transient Identity Keys. In some embodiments, the client device 130 and the AP 110 may determine a shared Pairwise Master Key (PMK) to establish a secure communication link. The PMK may be based, at least in part, on the Transient Identity Key pair.

The client device 130 may transmit the public Transient Identity Key to the certification authority 111. The certification authority 111 may include Certification Authority (CA) keys 112 (e.g., a private and a public CA key pair). The certification authority 111 may certify the public Transient Identity Key by signing the public Transient Identity Key with the private CA key. The certification authority 111 may also generate a certificate 131. The certificate 131 may include the public Transient Identity Key and the connection attributes of the client device 130. The certificate 131 may also be signed (e.g., certified) by the private CA key. The certification authority 111 may also generate an associated certificate identifier 132. The certificate identifier 132 may refer to (e.g., identify) the certificate 131. Thus, the certificate identifier 132 may provide an additional means for identifying the client device 130 and/or identifying the connection attributes associated with the client device 130. The certification authority 111 may provide the certified public Transient Identity Key, the certified certificate 131, and/or the certificate identifier 132 to the client device 130. The client device 130 may present the certified public Transient Identity Key, the signed certificate 131, and/or the certificate identifier 132 to other APs or wireless devices to identify and/or prove that the client device 130 has permission to connect to the other APs or wireless devices. The signed certificate 131 and/or the certificate identifier 132 may also be provided to, and stored within, the registration authority 141 or a memory associated with the smartphone 140. Operations associated with the registration authority 141 and the certification authority 111 are described in more detail below in conjunction with FIG. 2.

FIG. 2 shows an illustrative flow chart 200 depicting an example operation for authenticating and configuring the client device 130 for use with the AP 110, in accordance with example embodiments. Some embodiments may perform the operations described herein with additional operations, fewer operations, operations in a different order, operations in parallel, and/or some operations differently. Referring also to FIG. 1, the operation begins as the registration authority 141 determines the public Root Identity Key of the client device 130 (202). The public Root Identity Key may be part of a Root Identity Key pair associated with the client device 130 and may be determined in an out-of-band manner. In the example of FIG. 2, the registration authority 141 is included within the smartphone 140. In other embodiments, the registration authority 141 may be included within other wireless devices.

Next, the registration authority 141 determines the connection attributes of the client device 130 (204). In some embodiments, the user and/or network administrator may provide the connection attributes of the client device 130 through a user interface provided by the smartphone 140. In other embodiments, the connection attributes may be transmitted to, or retrieved by, the registration authority 141.

Next, the certification authority 111 receives the public Root Identity Key and the connection attributes of the client device 130 (206). In the example of FIG. 2, the certification authority 111 is included within the AP 110. In other embodiments, the certification authority 111 may be included within other wireless devices. In some embodiments, the public Root Identity Key and the connection attributes of the client device 130 may be transmitted to the certification authority 111 through a previously established secure connection (e.g., a secure connection between the smartphone 140 and the AP 110).

Next, the AP 110 authenticates the client device 130 based, at least in part, on the public Root Identity Key and the connection attributes (208a and 208b). For example, the AP 110 may provide a public key of the AP 110 encrypted by the public Root Identity Key to the client device 130. In addition, the AP 110 may examine the connection attributes of the client device 130 to determine that authentication is permitted based on any restrictions and/or conditions indicated by the connection attributes.

Next, the client device 130 generates the Transient Identity Key pair (210). The Transient Identity Key pair may include a public key and a private key. In some embodiments, the public Transient Identity Key pair may be transmitted to the AP 110 to configure the client device 130 for use with the AP 110.

Next, the certification authority 111 receives the public Transient Identity Key (212), certifies the public Transient Identity Key, and generates the certificate 131 and the certificate identifier 132 of the client device 130 (214). For example, the certification authority 111 may sign the public Transient Identity Key with the private CA key to certify the public Transient Identity Key. The certification authority 111 may generate the certificate 131 based, at least in part, on the public Transient Identity Key and/or the connection attributes of the client device 130. The certificate 131 may also be signed with the private CA key. The certification authority 111 may generate the certificate identifier 132 to identify the certificate 131. The certificate identifier 132 may also be certified with the private CA key. In place of, or in addition to generating the certificate 131 and/or the certificate identifier 132, the certification authority 111 may sign (e.g., certify) the connection attributes with the private CA key.

Next, the client device 130 may receive and store the certified public Transient Identity key, the public CA key, the certified certificate 131, the certificate identifier 132, and/or the certified connection attributes from the certification authority 111 (216). For example, the AP 110 may transmit the certified public Transient Identity Key, the public CA key, the certified certificate 131, the certificate identifier 132, and/or the certified connection attributes to the client device 130. As described above, the client device 130 may use the certified public Transient Identity Key, the certified certificate 131, the certificate identifier 132, and/or the certified connection attributes to connect to other wireless devices within the WLAN 120. The client device 130 may verify other certificates, certificate identifiers, public Transient Identity Keys, and or connection attributes provided by other wireless devices with the public CA key.

Next, the registration authority 141 may receive and store the certificate identifier 132 (218). In some embodiments, the registration authority 141 may also receive and store the certificate 131. In this manner, the registration authority 141 may compile a list of devices authorized (via the certification authority 111) to operate within the WLAN 120.

Next, the client device 130 and the AP 110 establish a communication link with each other (220a and 220b). For example, the client device 130 and the AP 110 may exchange one or more messages using the certified public Transient Identity Key. In some embodiments, the AP 110 and the client device 130 may determine a shared Pairwise Master Key to establish a secure communication link.

Although operations of flow chart 200 describe authenticating and configuring a single client device 130, the operations of flow chart 200 may be repeated any number of times to authenticate and configure any number of client devices. In addition, although described above as implemented within separate (e.g., distinct) devices, the registration authority 141 and the certification authority 111 may also be implemented within a common (e.g., single) device. For example, the smartphone 140 may execute software to function as both the registration authority 141 and the certification authority 111. Such a configuration may beneficially provide the client device 130 a certified Public Transient Identity and/or a certified certificate 131 in the absence of the AP 110.

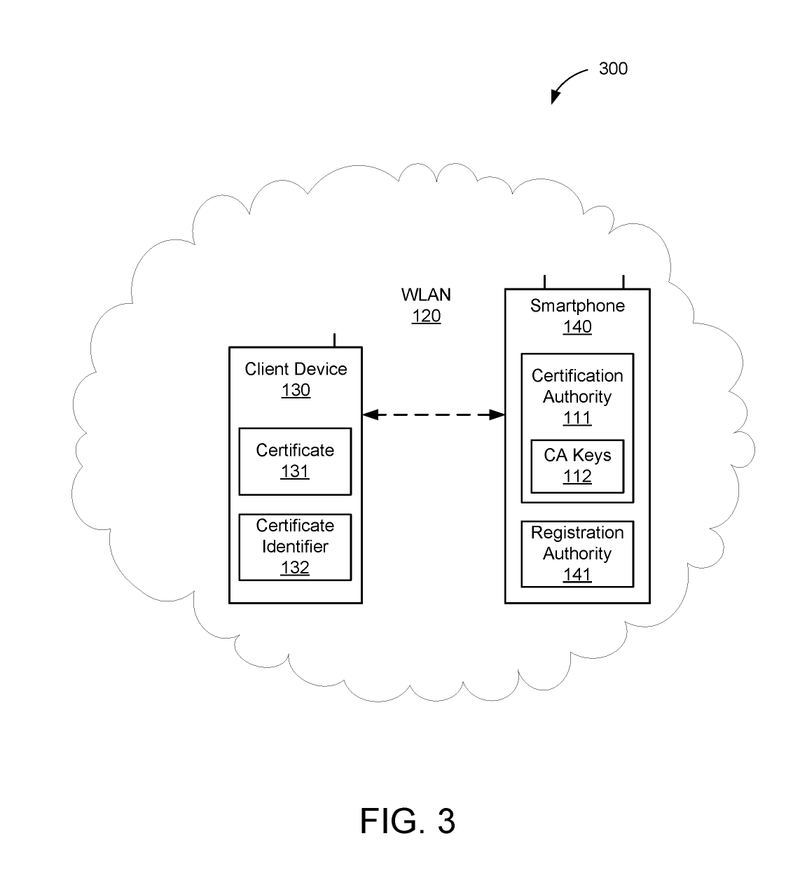

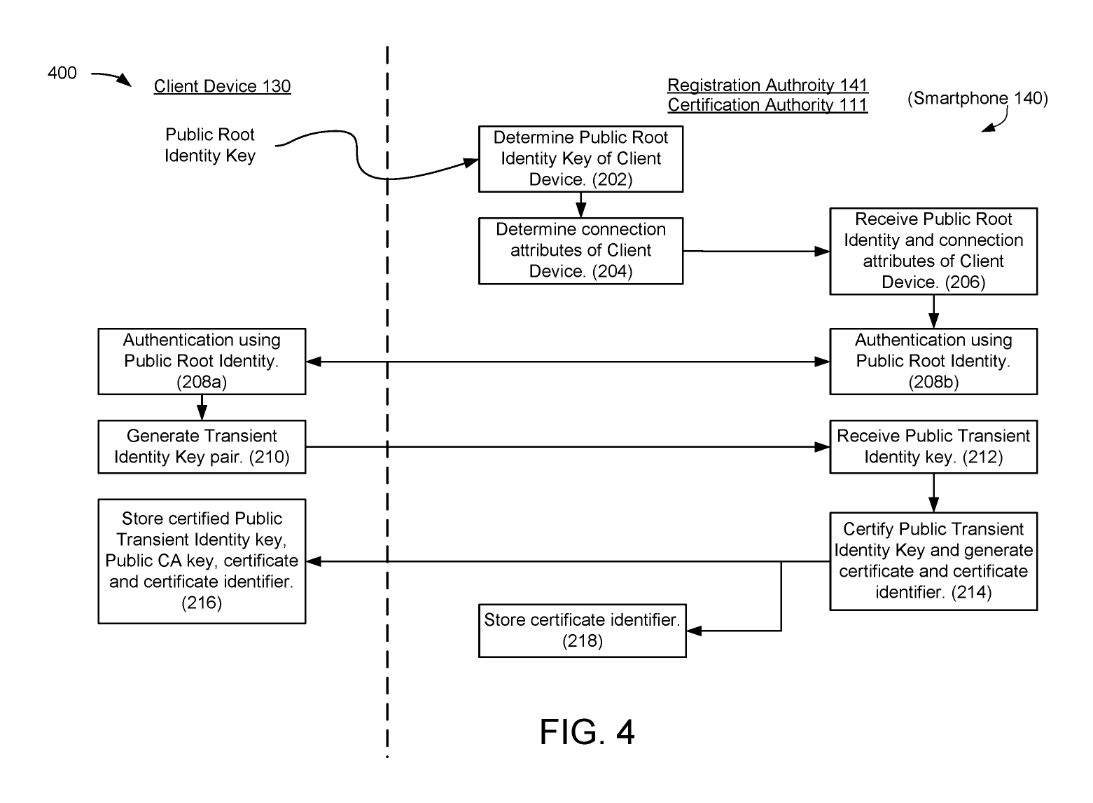

FIG. 3 is a block diagram of a wireless system 300 within which the example embodiments may be implemented. The wireless system 300 may include the client device 130, the smartphone 140, and the WLAN 120. In contrast to the wireless system 100, the smartphone 140 includes both the certification authority 111 and the registration authority 141. In other embodiments, other wireless devices included with the WLAN 120 may include the certification authority 111 and the registration authority 141 (not shown for simplicity). The certification authority 111 includes the CA keys 112. In some embodiments, the CA keys 112 may be stored in a secure memory within the smartphone 140 to prevent tampering. The smartphone 140 may authenticate and configure the client device 130 via the registration authority 141 and the certification authority 111. Thus, client device 130 may receive and store the certificate 131 and the certificate identifier 132 as described below in conjunction with FIG. 4.

FIG. 4 shows an illustrative flow chart 400 depicting another example operation for authenticating and configuring the client device 130, in accordance with example embodiments. In the example of FIG. 4, the registration authority 141 and the certification authority 111 are both implemented within a single device, such as the smartphone 140. Thus, some messages (e.g., communications) between the registration authority 141 and the certification authority 111 may be contained entirely within the smartphone 140. To emphasize the similarities between the example wireless system 100 of FIG. 1 and the example wireless system 300 of FIG. 3, operations of FIG. 4 are described with element numbers that correspond to similar operations described in FIG. 2. Thus, the operation begins as the registration authority 141 determines the public Root Identity Key of the client device 130 (202). The public Root Identity Key may be determined in an out-of-band manner. For example, the smartphone 140 may determine the public Root Identity Key through a camera, an NFC receiver, or a BLE receiver.

Next, the registration authority 141 determines the connection attributes of the client device 130 (204). For example, the user and/or network administrator may enter the connection attributes of the client device 130 through a user interface provided by the smartphone 140. In other embodiments, the connection attribute information may be transmitted to, or retrieved by, the registration authority 141. Next, the certification authority 111 receives the public Root Identity Key and the connection attributes of the client device 130 (206). Because the certification authority 111 and the registration authority 141 are both implemented within the smartphone 140, the public Root Identity Key and the connection attributes may be received through a message or a data structure, and not transmitted through a wireless communication medium.

Next, the smartphone 140 authenticates the client device 130 based, at least in part, on the Public Root Identity Key and the connection attributes (208a and 208b). For example, the smartphone 140 may provide the public key of the smartphone 140, as encrypted by the Public Root Identity Key, to the client device 130. In addition, the smartphone 140 may examine the connection attributes of the client device 130 to determine that authentication is permitted based on any restrictions and/or conditions indicated by the connection attributes.

Next the client device 130 generates the Transient Identity Key pair (210). The Transient Identity Key pair may configure the client device 130 for future use with the AP 110 (not shown for simplicity) or any other feasible device. Next, the certification authority 111 receives the public Transient Identity Key of the client device 130 (212), certifies the public Transient Identity Key, and generates the certificate 131 and the certificate identifier 132 of the client device 130 (214). For example, the certification authority 111 may sign the public Transient Identity Key with the private CA key to certify the public Transient Identity Key. The certification authority 111 may generate the certificate 131 based, at least in part, on the public Transient Identity Key and the connection attributes of the client device 130. The certificate 131 may also be signed with the private CA key. The certification authority 111 may generate the certificate identifier 132 to identify the certificate 131. The certificate identifier 132 may also be certified with the private CA key.

Next, the client device 130 may receive and store the certified Public Transient Identity key, the public CA key, the certified certificate 131, and/or the certificate identifier 132 from the certification authority 111 (216). The client device 130 may use the certified public Transient Identity Key, the certified certificate 131, and/or the certificate identifier 132 to verify the authorization of, and to connect to, other wireless devices within the WLAN 120. The client device 130 may use the public CA key to verify other certificates, certificate identifiers, and/or the public Transient Identity keys provided by other wireless devices.

Next, the registration authority 141 may receive and store the certificate identifier 132 of client device 130 (218). In some embodiments, the registration authority 141 may also receive and store the certificate 131. Although the client device 130 may not be presently connected to the AP 110, the registration authority 141 may still compile a list of client devices authorized to operate within the WLAN 120.

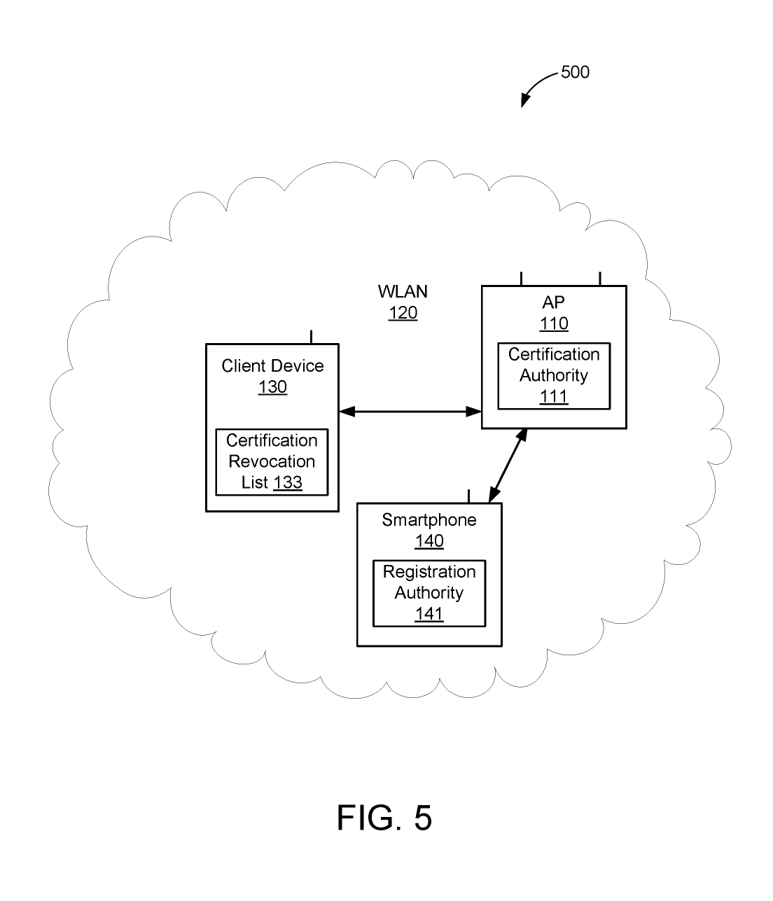

FIG. 5 is a block diagram of a wireless system 500 within which example embodiments may be implemented. The wireless system 500 may include the client device 130, the AP 110, the smartphone 140, and the WLAN 120. The AP 110 may include the certification authority 111, and the smartphone 140 may include the registration authority 141. The registration authority 141 may control the access of other client devices (not shown for simplicity) to the WLAN 120. In some embodiments, the user and/or network administrator may choose (through the registration authority 141) to remove access of a client device from the WLAN 120. The registration authority 141 may inform the certification authority 111 of the selected client device. In response, the certification authority 111 may generate a certification revocation list (CRL) 133 of client devices no longer authorized to access the WLAN 120 or wireless devices within the WLAN 120. The certification authority 111 may certify the CRL 133, which may then be transmitted to client devices (e.g., the client device 130) within the WLAN 120. Before connecting to a wireless device, the client device 130 may reference the CRL 133 to ensure that the wireless device is authorized to operate.

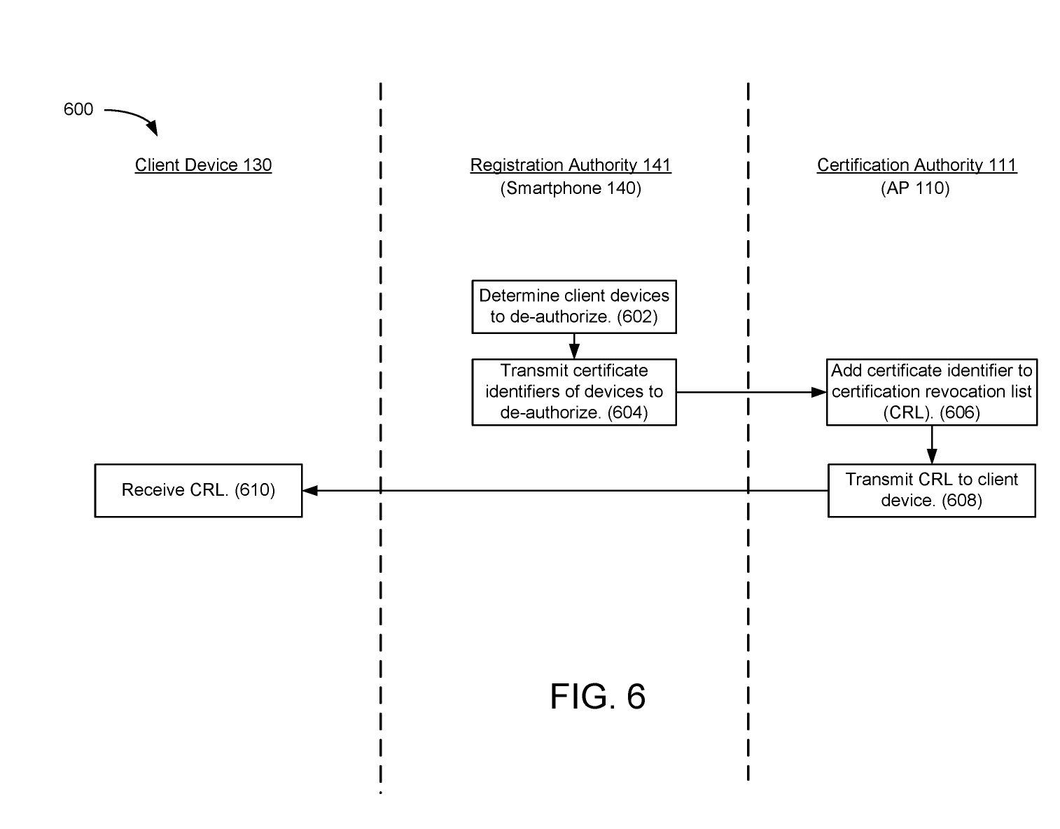

FIG. 6 shows an illustrative flow chart 600 depicting an example operation for de-authorizing one or more devices within the WLAN 120, in accordance with example embodiments. In the example of FIG. 6, the registration authority 141 is included within the smartphone 140, and the certification authority 111 is included within the AP 110. In other embodiments, the registration authority 141 and the certification authority 111 may be included in other wireless devices. Referring also to FIG. 5, operations begin as the registration authority 141 determines client devices to de-authorize (602). For example, the registration authority 141 may receive a user input to remove the access of one or more client devices from the WLAN 120. In another example, the registration authority 141 may examine connection attributes associated with the client devices and determine that one or more of the client devices are no longer authorized to connect to the WLAN 120. For instance, the connection attributes may indicate that the permitted access time for the associated client device has elapsed.

Next, the registration authority 141 transmits the certificate identifier 132 of the client devices to be de-authorized to the certification authority 111 (604). In some embodiments, the certificate identifiers 132 of the client devices may be stored within the registration authority 141 (see operation 218 of FIGS. 2 and 4). Thus, the certificate identifiers 132 corresponding to the client devices (as determined at 602) may be transmitted to the certification authority 111. Next, the certification authority 111 adds the certificate identifiers 132 of the client devices to be de-authorized to the CRL 133 (606). If the CRL 133 does not exist, then the certification authority 111 may create the CRL 133. The certification authority 111 may certify the CRL 133 by signing the CRL 133 with the private CA key.

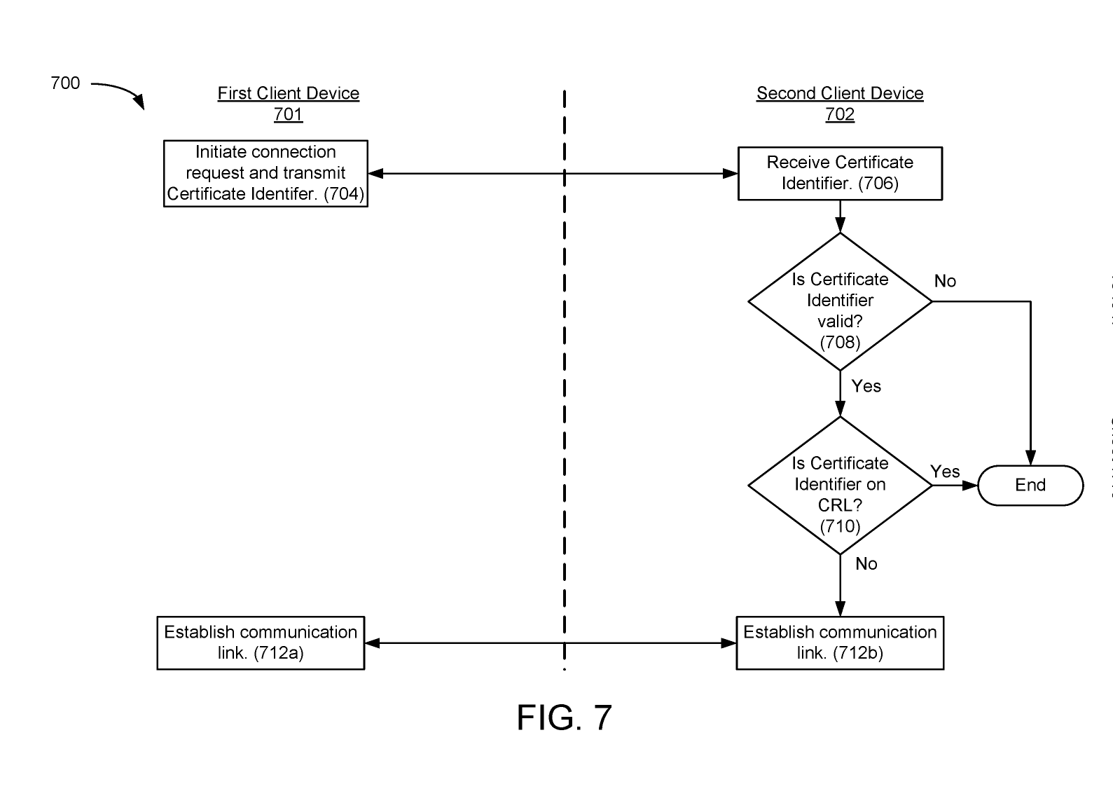

Next, the CRL 133 is transmitted to the client device 130 (608). For simplicity, FIG. 6 shows a single client device 130. In other embodiments, the CRL 133 may be transmitted to any number of client devices. Next, client device 130 receives the CRL 133 (610). In some embodiments, the client device 130 may verify the CRL 133 with the public CA key. The client device 130 may also store the CRL 133. The CRL 133 may control the connection of client devices to the AP 110 or to each other. An example operation is described below in conjunction with FIG. 7.

FIG. 7 shows an illustrative flow chart 700 depicting an operation for establishing communications between two client devices, in accordance with example embodiments. Although FIG. 7 shows only a first client device 701 and a second client device 702, in other embodiments, communication between any technically feasible number of client devices may be established. Client devices 701 and 702 may be one embodiment of the client device 130 of FIG. 5. Operations begin as the first client device 701 initiates a connection request and transmits a first certificate identifier to the second client device 702 (704). The first certificate identifier may be signed with the private CA key (see operation 214 in FIGS. 2 and 4).

Next, the second client device 702 receives the first certificate identifier (706), and the second client device 702 verifies the first certificate identifier (708). In some embodiments, the second client device 702 may use the public CA key (stored therein) to ensure that the first certificate identifier is valid. If the first certificate identifier is not valid, then the operation ends. On the other hand, if the first certificate identifier is valid, then the second client device 702 determines if the first certificate identifier is listed on the CRL 133 (710).

If the first certificate identifier is listed on the CRL 133, then the second client device 702 may refuse the connection request and the operation ends. On the other hand, if the first certificate identifier is not listed on the CRL 133, then the second client device 702 may establish a communication link with the first client device 701 (712a and 712b). For example, the first client device 701 may communicate with the second client device 702 through a Wi-Fi direct or a peer-to-peer protocol. In other embodiments, the first client device 701 and the second client device 702 may use any other technically feasible communication protocol.

Although described above with respect to the first client device 701 initiating the connection request, in other embodiments, the second client device 702 may initiate the connection request. For example, the second client device 702 may initiate the connection request and transmit a second certificate identifier to the first client device 701. In still other embodiments, the first client device 701 and the second client device 702 may initiate connection requests in parallel.

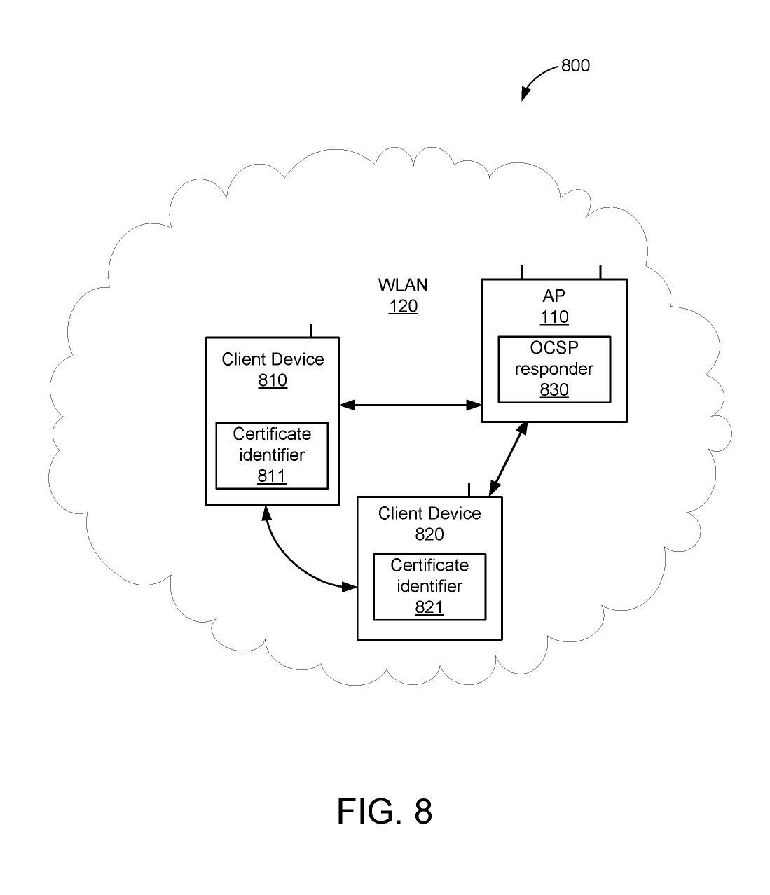

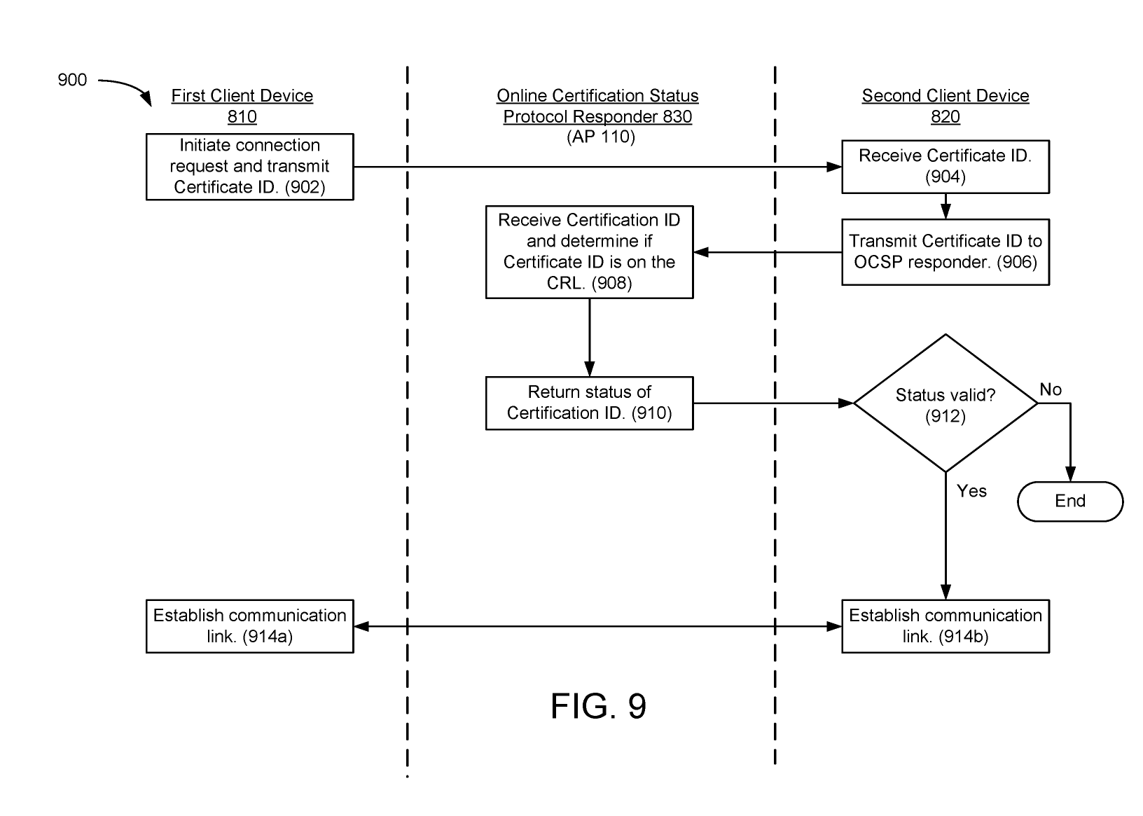

FIG. 8 is a block diagram of a wireless system 800 within which example embodiments may be implemented. The wireless system 800 may include a first client device 810, a second client device 820, the AP 110, and the WLAN 120. The first client device 810 may be another embodiment of the first client device 701, and the second client device 820 may be another embodiment of the second client device 702. The first client device 810 may include the first certificate identifier 811, and the second client device 802 may include the second certificate identifier 821. The first certificate identifier 811 and the second certificate identifier 821 may each be an embodiment of the certificate identifier 132. The AP 110 may include an Online Certification Status Protocol (OCSP) responder 830. In some embodiments, the OCSP responder 830 may inspect and return a status associated with a certificate identifier (e.g., first certificate identifier 811 or second certificate identifier 821). For example, the OCSP responder 830 may determine whether a certificate identifier is valid (e.g., not listed on the CRL 133) and whether a client device may connect to the device corresponding the certificate identifier. An example operation validating certificate identifiers via the OCSP responder 830 is described below in conjunction with FIG. 9.

FIG. 9 shows an illustrative flow chart 900 depicting another operation for establishing communications between two client devices, in accordance with example embodiments. Although FIG. 9 shows only the first client device 810 and the second client device 820, in other embodiments, communications between any technically feasible number of client devices may be established. Operations begin as the first client device 810 initiates a connection request and transmits the first certificate identifier 811 to the second client device 820 (902). Next, after receiving the first certificate identifier 811 (904), the second client device 820 transmits the first certificate identifier 811 to the OCSP responder 830 (906). In some embodiments, the AP 110 may include the OCSP responder 830. In other embodiments, the OCSP responder 830 may be included within other wireless devices.

The OCSP responder 830 may have access to, or a copy of, a current version of the CRL 133. For example, the AP 110 may also include the certification authority 111 and/or the registration authority 141 (not shown for simplicity) and, therefore, may have access to the CRL 133. Thus, the OCSP responder 830 may receive the first certificate identifier 811 and determine a status based, at least in part, on the CRL 133 (908). For example, the OCSP responder 830 may determine whether the first certificate identifier 811 is listed on the CRL 133. Next, the OCSP responder 830 may return a status of the first certificate identifier 811 to the second client device 802 (910). The status may indicate whether the first certificate identifier 811 is valid or invalid.

Next, the status of the first certificate identifier 811 is determined by the second client device 820 (912). If the status of the first certificate identifier 811 is not valid, then the operation ends. On the other hand, if the status of the first certificate identifier 811 is valid, then the second client device 820 may establish a communication link with the first client device 810 (914a and 914b). For example, the first client device 810 may communicate with the second client device 820 through a Wi-Fi direct or peer-to-peer protocol. In other embodiments, the first client device 810 and the second client device 820 may use any other technically feasible communication protocol.

Although described with respect to the first client device 810 initiating the connection request, in other embodiments, the second client device 820 may initiate the connection request. For example, the second client device 820 may initiate the connection request and transmit the second certificate identifier 821 to the first client device 810. In still other embodiments, the first client device 810 and the second client device 820 may initiate connection requests in parallel.

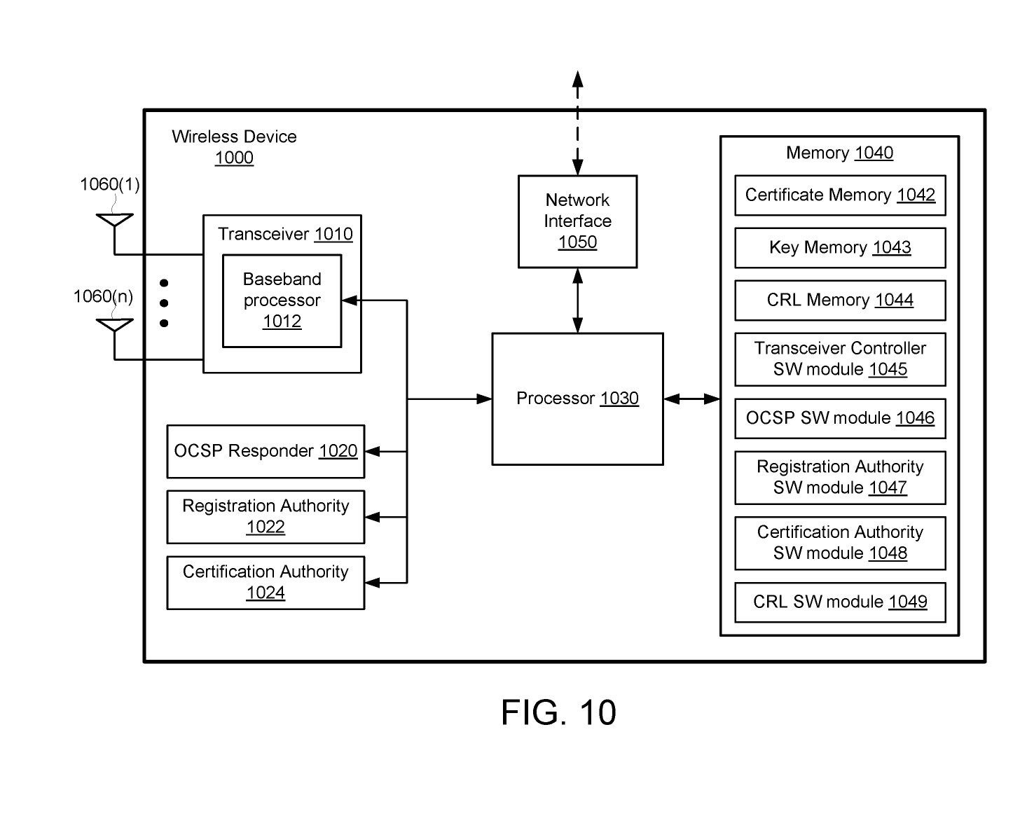

FIG. 10 shows an example wireless device 1000 that may be an embodiment of the AP 110, the client device 130, and/or the smartphone 140 of FIG. 1. The wireless device 1000 may include a transceiver 1010, an OCSP responder 1020, a registration authority 1022, a certification authority 1024, a processor 1030, a memory 1040, a network interface 1050, and a number of antennas 1060(1)-1060(n). The OCSP responder 1020 may be an embodiment of the OCSP responder 830 of FIG. 8. The registration authority 1022 may be an embodiment of the registration authority 141 of FIG. 1. The certification authority 1024 may be an embodiment of the certification authority 111 of FIG. 1. The transceiver 1010 may be coupled to antennas 1060(1)-1060(n), either directly or through an antenna selection circuit (not shown for simplicity). The transceiver 1010 may communicate wirelessly with one or more client devices, with one or more APs, and/or with other suitable devices. Although not shown in FIG. 10 for simplicity, the transceiver 1010 may include any number of transmit chains to process and transmit signals to other wireless devices via antennas 1060(1)-1060(n), and may include any number of receive chains to process signals received from antennas 1060(1)-1060(n). Thus, for example embodiments, the wireless device 1000 may be configured for MIMO operations including, for example, SU-MIMO operations and MU-MIMO operations.

The transceiver 1010 may include a baseband processor 1012. The baseband processor 1012 may process signals received from the processor 1030 and/or the memory 1040 and may transmit the processed signals via one or more of antennas 1060(1)-1060(n). Additionally, the baseband processor 1012 may process signals received from one or more of antennas 1060(1)-1060(n) and may forward the processed signals to the processor 1030 and/or the memory 1040.

The network interface 1050 may access other networks and/or services. In some embodiments, the network interface 1050 may include a wired interface. The network interface 1050 may also communicate with a WLAN server (not shown for simplicity) either directly or via one or more intervening networks.

The processor 1030, which is coupled to the transceiver 1010, the OCSP responder 1020, the registration authority 1022, the certification authority 1024, the network interface 1050, and the memory 1040, may be any suitable one or more processors capable of executing scripts or instructions of one or more software programs stored in the wireless device 1000 (e.g., within the memory 1040). For actual embodiments, the transceiver 1010, the processor 1030, the memory 1040, and/or the network interface 1050 may be connected together using one or more buses (not shown for simplicity).

The memory 1040 may include a certificate memory 1042 to store certificates (e.g., certificate 131) and/or certificate identifiers (e.g., certificate identifier 132). In some embodiments, the certificates and/or the certificate identifiers may be generated by the certification authority 1024 and/or a certification authority software module 1048 (described below).

The memory 1040 may include a key memory 1043 to store public, private, and/or shared keys. In some embodiments, the wireless device 1000 may generate the public, private, and/or shared keys. In other embodiments, the public, private, and/or shared keys may be received through the transceiver 1010. For example, the transceiver 1010 may receive the CA keys 112 which may be stored in the key memory 1043. In some embodiments, increased protection may be provided to the key memory 1043 to safeguard sensitive keys, such as the private CA key.

The memory 1040 may include a CRL memory 1044. The CRL memory may store the CRL 133 (not shown for simplicity). The CRL 133 may be certified by the private CA key. In some embodiments, the CRL 133 may be verified with the public CA key stored in the key memory 1043.

The memory 1040 may also include a non-transitory computer-readable medium (e.g., one or more nonvolatile memory elements, such as EPROM, EEPROM, Flash memory, a hard drive, and so on) that may store at least the following software (SW) modules:
a transceiver controller software module 1045 to transmit and receive wireless data through the transceiver 1010;
an OCSP software module 1046 to perform operations associated with the OCSP responder 1020;
a registration authority software module 1047 to perform operations associated with the registration authority 1022;
a certification authority software module 1048 to perform operations associated with the certification authority 1024; and
a CRL software module 1049 to perform operations associated the generation and maintenance of the CRL 133.
   Each software module includes instructions that, when executed by the processor 1030, cause the wireless device 1000 to perform the corresponding functions. Thus, the non-transitory computer-readable medium of the memory 1040 includes instructions for performing all or a portion of the operations depicted in FIGS. 2, 4, 6, 7, and 9.

As mentioned above, the processor 1030 may be any suitable one or more processors capable of executing scripts or instructions of one or more software programs stored in the wireless device 1000 (e.g., within the memory 1040). For example, the processor 1030 may execute the transceiver controller software module 1045 to facilitate the transmission and/or reception of data between the wireless device 1000 and other wireless devices (not shown for simplicity).

The processor 1030 may execute the OCSP software module 1046 to determine the status of certificate identifiers. For example, the OCSP software module 1046 may determine the status of the certificate identifier 132 by examining the CRL 133 stored in the CRL memory 1044.

The processor 1030 may execute the registration authority software module 1047 to determine public keys and connection attributes of the wireless device 1000. For example, the registration authority software module 1047 may determine the public Root Identity Key of the client device 130 in an out-of-band manner and provide the public Root Identity Key to the certification authority 1024. The registration authority software module 1047 may also determine the connection attributes of the wireless device 1000 and provide them to the certification authority 1024.

The processor 1030 may execute the certification authority software module 1048 to receive keys and the connection attributes of the wireless device 1000 and generate the certificate 131 and the certificate identifier 132 associated with the wireless device 1000. The certificate 131 and the certificate identifier 132 may be stored in the certificate memory 1042. In some embodiments, the certification authority software module 1048 may certify the certificate 131 and/or the certificate identifier 132 via the private CA key.

The processor 1030 may execute the CRL software module 1049 to generate and/or certify the CRL 133. For example, the processor 1030 may execute the CRL software module 1049 to generate the CRL 133 based, at least in part, on the certificate identifiers stored within the certificate memory 1042. The CRL 133 may be stored in the CRL memory 1044.

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences, or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, the example embodiments have been described with reference to specific example embodiments thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method of configuring a client device for use in a wireless network, the method comprising:
authenticating, at a certification authority, the client device based, at least in part, on a public root identity key of the client device;
receiving, at the certification authority, a public transient identity key and a connection attribute of the client device;
certifying the public transient identity key and the connection attribute with a private certification authority key; and
transmitting the certified public transient identity key and the certified connection attribute to the client device.

2. The method of claim 1, wherein the authenticating is in response to receiving the public root identity key.

3. The method of claim 1, wherein the connection attribute is received from a registration authority, distinct from the client device.

4. The method of claim 1, wherein the connection attribute includes at least one of a device name, or a data throughput limit, or a connection profile, or a combination thereof.

5. The method of claim 1, further comprising:
generating a certificate based, at least in part, on the connection attribute and the public transient identity key; and
transmitting the certificate to the client device.

6. The method of claim 5, wherein the certificate is signed with a private certification authority key.

7. The method of claim 5, further comprising:
transmitting the certificate to a registration authority, distinct from the client device.

8. The method of claim 1, further comprising:
establishing a communication link with the client device based, at least in part, on the public transient identity key.

9. A wireless device comprising:
a transceiver;
a processor; and
a memory storing instructions that when executed by the processor cause the wireless device to:
authenticate, at a certification authority, a client device based, at least in part, on a public root identity key of the client device;
receive, at the certification authority, a public transient identity key and a connection attribute of the client device;
certify the public transient identity key and the connection attribute with a private certification authority key; and
transmit the certified public transient identity key and the certified connection attribute to the client device.

10. The wireless device of claim 9, wherein the connection attribute is received from a registration authority, distinct from the client device.

11. The wireless device of claim 9, wherein the connection attribute includes at least one or a device name, or a data throughput limit, or a connection profile, or a combination thereof.

12. The wireless device of claim 9, wherein execution of the instructions cause the wireless device to further:
generate a certificate based, at least in part, on the connection attribute and the public transient identity key; and
transmit the certificate to the client device.

13. The wireless device of claim 12, wherein the certificate is signed with a private certification authority key.

14. The wireless device of claim 12, wherein execution of the instructions cause the wireless device to further:
transmit the certificate to a registration authority, distinct from the client device.

15. The wireless device of claim 9, wherein execution of the instructions cause the wireless device to further:
establish a communication link with the client device based, at least in part, on the public transient identity key.

16. A wireless device comprising:
means for authenticating a client device based, at least in part, on a public root identity key of the client device;
means for receiving a public transient identity key and a connection attribute of the client device;
means for certifying the public transient identity key and the connection attribute with a private certification authority key; and
means for transmitting the certified public transient identity key and the certified connection attribute to the client device.

17. The wireless device of claim 16, wherein the connection attribute is received from a registration authority, distinct from the client device.

18. The wireless device of claim 16, wherein the connection attribute includes at least one of a device name, or a data throughput limit, or a connection profile, or a combination thereof.

19. The wireless device of claim 16, further comprising:
means for generating a certificate based, at least in part, on the connection attribute and the public transient identity key; and
means for transmitting the certificate to the client device.

20. The wireless device of claim 19, wherein the certificate is signed with a private certification authority key.

21. The wireless device of claim 19, further comprising:
means for transmitting the certificate to a registration authority, distinct from the client device.

22. The wireless device of claim 16, further comprising:
means for establishing a communication link with the client device based, at least in part, on the public transient identity key.

23. A non-transitory computer-readable medium storing instructions that, when executed by a processor of a wireless device, cause the wireless device to:
authenticate, at a certification authority, a client device based, at least in part, on a public root identity key of the client device;
receive, at the certification authority, a public transient identity key and a connection attribute of the client device;
certify the public transient identity key and the connection attribute with a private certification authority key; and
transmit the certified public transient identity key and the certified connection attribute to the client device.

24. The non-transitory computer-readable medium of claim 23, wherein the connection attribute is received from a registration authority, distinct from the client device.

25. The non-transitory computer-readable medium of claim 23, wherein the connection attribute includes at least one or a device name, or a data throughput limit, or a connection profile, or a combination thereof.

26. The non-transitory computer-readable medium of claim 23, wherein execution of the instructions cause the wireless device to further:
generate a certificate based, at least in part, on the connection attribute and the public transient identity key; and
transmit the certificate to the client device.

27. A method of establishing a communication link to a first wireless device, the method comprising:
transmitting a certificate identifier associated with a second wireless device to a certification status responder;
receiving a status of a certificate corresponding to the certificate identifier from the certification status responder; and
establishing the communication link based, at least in part, on the status of the certificate.

28. The method of claim 27, wherein the status is based, at least in part, on a certification revocation list.

29. The method of claim 27, wherein the certification status responder is distinct from the first wireless device and the second wireless device.

30. The method of claim 27, wherein the communication link is a Wi-Fi direct or peer-to-peer link.
